(19) United States
(12) Patent Application Publication
(10) Pub. No.: US 2014/0258139 A1
(43) Pub. Date: Sep. 11, 2014

(54) INFORMATION PROCESSING SYSTEM, INFORMATION PROCESSING APPARATUS, AND OPERATION-STATE PREDICTION METHOD

(71) Applicant: Kenji KAWASUMI, Kanagawa (JP)

(72) Inventor: Kenji KAWASUMI, Kanagawa (JP)

(21) Appl. No.: 14/198,797

(22) Filed: Mar. 6, 2014

(30) Foreign Application Priority Data
Mar. 7, 2013 (JP) 2013-045846
Sep. 27, 2013 (JP) 2013-202189

(51) Int. Cl. G06Q 30/00

(52) U.S. Cl. CPC G06Q 30/016
USPC 705/304

(57) ABSTRACT

An information processing system includes a device-information acquiring part, a failure-information acquiring part, and a predicting part. The device-information acquiring part acquires device information indicating at least a model of a given device. The failure-information acquiring part acquires failure information on a failure occurred in the same model of device as the model indicated by the device information among managed object devices. The predicting part predicts an operation state of the given device on the basis of the failure information.

### CROSS-REFERENCE TO RELATED APPLICATIONS

The present application claims priority to and incorporates by reference the entire contents of Japanese Patent Application No. 2013-045846 filed in Japan on Mar. 7, 2013 and Japanese Patent Application No. 2013-202189 filed in Japan on Sep. 27, 2013.

### BACKGROUND OF THE INVENTION

1. Field of the Invention

The present invention relates to an information processing system, an information processing apparatus, and an operation-state prediction method.

2. Description of the Related Art

Conventionally, in the field of managed print service (MPS), there is known a technology to manage an operation state of a device, such as an operation rate of the device in customer environment, the number of failures, and content of failure, and provide the operation state of the device as a service report to a customer (for example, see Japanese Patent Application Laid-open No. 2011-100283).

However, in conventional technologies as described above, a service report is used only for the purpose of checking whether or not an agreement made with a customer has been kept, and information on a device accumulated every day in management of an operation state of the device has not been utilized for service such as MPS, for example, in such a way that device operation information is used for setting contents of an agreement made with a customer.

In view of the above situation, there is a need to provide an information processing system, information processing apparatus, and operation-state prediction method capable of utilizing accumulated information on a device for service.

### SUMMARY OF THE INVENTION

It is an object of the present invention to at least partially solve the problems in the conventional technology.

According to the present invention, there is provided an information processing system comprising: a device-information acquiring part configured to acquire device information indicating at least a model of a given device; a failure-information acquiring part configured to acquire failure information on a failure occurred in a device corresponding to the model indicated by the device information among managed object devices; and a predicting part configured to predict an operation state of the given device on the basis of the failure information.

The present invention also provides an information processing apparatus comprising: a device-information acquiring part configured to acquire device information indicating at least a model of a given device; a failure-information acquiring part configured to acquire failure information on a failure occurred in a device corresponding to the model indicated by the device information among managed object devices; and a predicting part configured to predict an operation state of the given device on the basis of the failure information.

The present invention also provides an operation-state prediction method comprising: acquiring device information indicating at least a model of a given device; acquiring failure information on a failure occurred in a device corresponding to the model indicated by the device information among managed object devices; and predicting an operation state of the given device on the basis of the failure information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram showing an example of a configuration of an information processing system according to a present embodiment;

FIG. 2 is a block diagram showing an example of a configuration of a customer management apparatus according to the present embodiment;

FIG. 3 is a diagram showing an example of customer information according to the present embodiment;

FIG. 4 is a block diagram showing an example of a configuration of a group management apparatus according to the present embodiment;

FIG. 5 is a diagram showing an example of group information according to the present embodiment;

FIG. 6 is a block diagram showing an example of a configuration of a device management apparatus according to the present embodiment;

FIG. 7 is a diagram showing an example of device information according to the present embodiment;

FIG. 8 is a block diagram showing an example of a configuration of a failure management apparatus according to the present embodiment;

FIG. 9 is a diagram showing an example of failure information according to the present embodiment;

FIG. 10 is a block diagram showing an example of a configuration of an information processing apparatus according to the present embodiment;

FIG. 11 is a diagram showing an example of a hierarchy of customer information, group information, device information, and failure information according to the present embodiment;

FIG. 12 is a flowchart showing an example of an expected-operation-rate calculating process performed by the information processing system according to the present embodiment; and

FIG. 13 is a block diagram showing an example of a hardware configuration of each apparatus according to the present embodiment.

### DETAILED DESCRIPTION OF THE PREFERRED EMBODIMENTS

An exemplary embodiment of an information processing system, information processing apparatus, program, and operation-state prediction method according to the present invention will be explained in detail below with reference to accompanying drawings.

First, a configuration of the information processing system according to the present embodiment is explained.

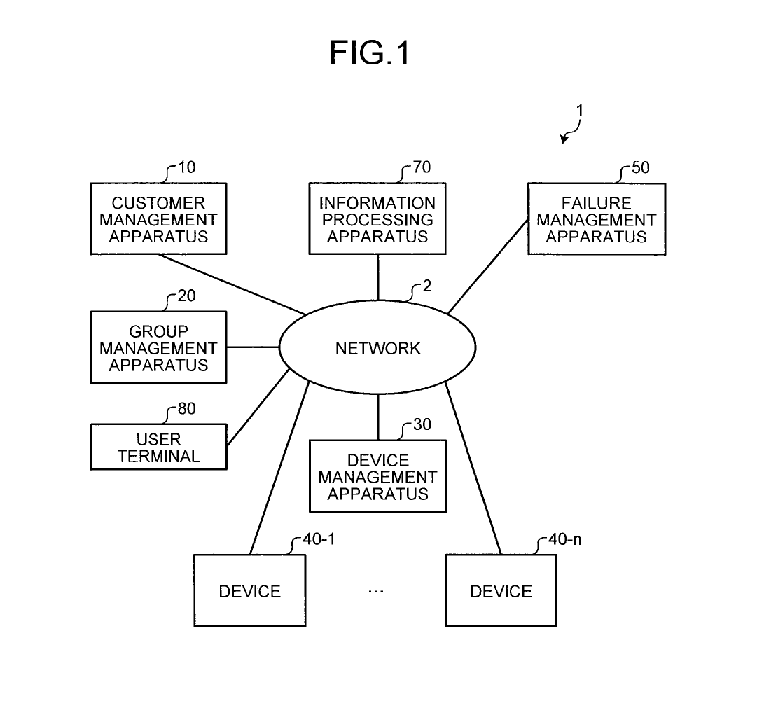

FIG. 1 is a block diagram showing an example of a configuration of an information processing system 1 according to the present embodiment. As shown in FIG. 1, the information processing system 1 includes a customer management apparatus 10, a group management apparatus 20, a device management apparatus 30, devices 40-1 to 40-n (n≧1), a failure management apparatus 50, an information processing apparatus 70, and a user terminal 80. The customer management apparatus 10, the group management apparatus 20, the device management apparatus 30, the devices 40-1 to 40-n, the failure management apparatus 50, the information processing apparatus 70, and the user terminal 80 are connected via a network 2. The network 2 can be realized by means of, for example, the Internet or a local area network (LAN), etc.

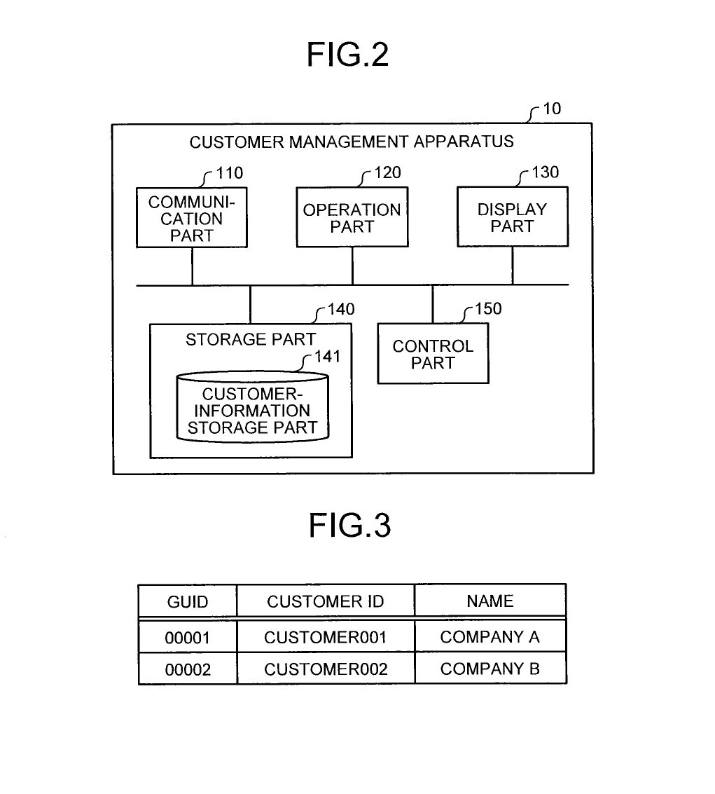

FIG. 2 is a block diagram showing an example of a configuration of the customer management apparatus 10 according to the present embodiment. The customer management apparatus 10 manages customer information, and, as shown in FIG. 2, includes a communication part 110, an operation part 120, a display part 130, a storage part 140, and a control part 150.

The communication part 110 communicates with an external device, such as the information processing apparatus 70, via the network 2, and can be realized by means of a communication device such as a network interface card (NIC).

The operation part 120 is a part through which inputs of various operations are made, and can be realized by means of an input device such as a keyboard and a mouse, a touchpad, or a touch panel.

The display part 130 displays thereon various screens, and can be realized by means of a display device such as a liquid crystal display or a touch panel display.

The storage part 140 stores therein various programs executed by the customer management apparatus 10 and data used in various processes performed by the customer management apparatus 10. The storage part 140 can be realized by means of at least any of a magnetically-recordable storage device, an optically-recordable storage device, and an electrically-recordable storage device, such as a hard disk drive (HDD), a solid state drive (SSD), a memory card, an optical disk, and a random access memory (RAM). The storage part 140 includes a customer-information storage part 141.

The customer-information storage part 141 stores therein customer information which is information on a customer. FIG. 3 is a diagram showing an example of the customer information according to the present embodiment. In the example shown in FIG. 3, the customer information is information in which globally unique identifier (GUID), Customer ID, and Name are associated. The GUID denotes an identifier that identifies a record of customer information (a column of customer information). The Customer ID (an example of customer identifying information) denotes an identifier that identifies a customer. The Name denotes a name of the customer.

The control part 150 controls the parts included in the customer management apparatus 10, and can be realized by means of a control device such as a central processing unit (CPU). The control part 150 manages the input/output of customer information stored in the customer-information storage part 141.

For example, when new customer information or update of existing customer information has been input by an administrator of the customer management apparatus 10 through the operation part 120, the control part 150 updates the customer information stored in the customer-information storage part 141. Furthermore, for example, when Name has been input from the information processing apparatus 70 through the communication part 110, the control part 150 acquires a record of customer information including the Name from the customer information stored in the customer-information storage part 141 and returns the acquired customer information to the information processing apparatus 70. Incidentally, the record of customer information that the control part 150 acquires has only to include at least Customer ID associated with the Name.

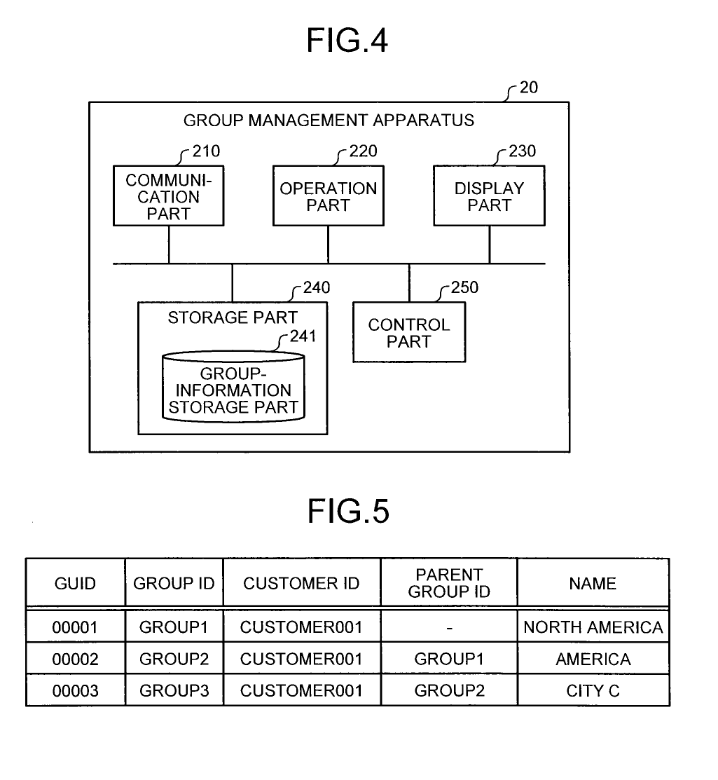

FIG. 4 is a block diagram showing an example of a configuration of the group management apparatus 20 according to the present embodiment. The group management apparatus 20 manages group information, and, as shown in FIG. 4, includes a communication part 210, an operation part 220, a display part 230, a storage part 240, and a control part 250.

The communication part 210 communicates with an external device, such as the information processing apparatus 70, via the network 2, and can be realized by means of an NIC or the like.

The operation part 220 is a part through which inputs of various operations are made, and can be realized by means of an input device such as a keyboard, a mouse, a touchpad, or a touch panel.

The display part 230 displays thereon various screens, and can be realized by means of a display device such as a liquid crystal display or a touch panel display.

The storage part 240 stores therein various programs executed by the group management apparatus 20 and data used in various processes performed by the group management apparatus 20. The storage part 240 can be realized by means of at least any of a magnetically-recordable storage device, an optically-recordable storage device, and an electrically-recordable storage device, such as an HDD, an SSD, a memory card, an optical disk, and a RAM. The storage part 240 includes a group-information storage part 241.

The group-information storage part 241 stores therein group information which is information on a customer's group. The customer's group includes subgroups into which the customer's group is subdivided, and corresponds to, for example, a customer's regional structure, such as continent, country/region, and city, or a customer's organizational structure; however, it is not limited to these. Furthermore, groups can have a hierarchical structure.

FIG. 5 is a diagram showing an example of the group information according to the present embodiment. In the example shown in FIG. 5, the group information is information in which GUID, Group ID, Customer ID, Parent Group ID, and Name are associated. The GUID denotes an identifier that identifies a record of group information (a column of group information). The Group ID (an example of group identifying information) denotes an identifier that identifies a group. The Customer ID denotes an identifier that identifies a customer. The Parent Group ID denotes an identifier that identifies a parent group. The Name denotes a name of the group.

In the example shown in FIGS. 3 and 5, a group (a regional structure) of Company A with Customer ID “CUSTOMER001” has a hierarchical structure that America with Group ID “GROUP2” belongs to North America with Group ID “GROUP1”, and City C with Group ID “GROUP3” belongs to America with Group ID “GROUP2”.

The control part 250 controls the parts included in the group management apparatus 20, and can be realized by means of a control device such as a CPU. The control part 250 manages the input/output of group information stored in the group-information storage part 241.

For example, when new group information or update of existing group information has been input by an administrator of the group management apparatus 20 through the operation part 220, the control part 250 updates the group information stored in the group-information storage part 241. Furthermore, for example, when Customer ID has been input from the information processing apparatus 70 through the communication part 210, the control part 250 acquires a record of group information including the Customer ID from the group information stored in the group-information storage part 241 and returns the acquired group information to the information processing apparatus 70. Incidentally, the record of group information that the control part 250 acquires has only to include at least Group ID associated with the Customer ID.

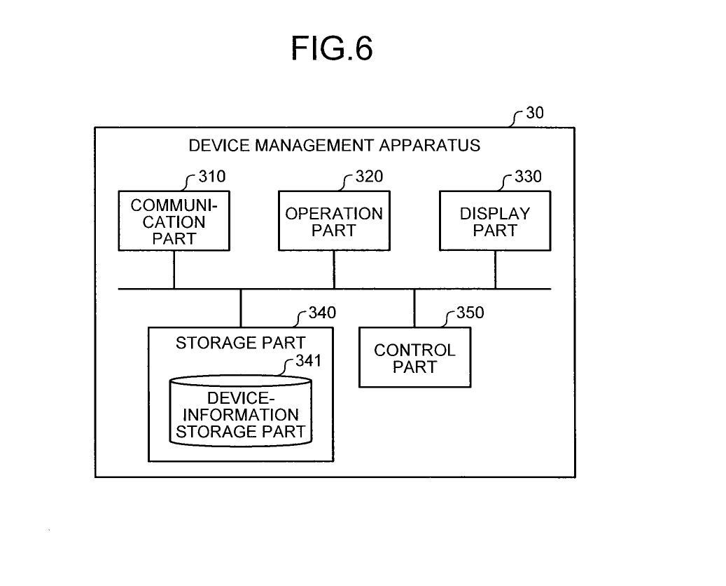

FIG. 6 is a block diagram showing an example of a configuration of the device management apparatus 30 according to the present embodiment. The device management apparatus 30 manages device information of the devices 40-1 to 40-n (an example of managed object devices), and, as shown in FIG. 6, includes a communication part 310, an operation part 320, a display part 330, a storage part 340, and a control part 350.

The devices 40-1 to 40-n can be any types of devices as long as the devices can be connected to the network 2, and include, for example, image forming apparatuses such as a printer, a copier, a multifunction peripheral (MFP), a scanner device, and a facsimile device, various electronic devices such as a projector, a camera, an air conditioner, a refrigerator, a fluorescent light, a vending machine, and a handheld terminal, a PC, and a tablet computer, etc. An MFP is a device having at least two functions out of a copy function, a print function, a scanner function, and a facsimile function. In the present embodiment, the devices 40-1 to 40-n shall be MFPs; however, types of the devices 40-1 to 40-n are not limited to this.

The communication part 310 communicates with external devices, such as the devices 40-1 to 40-n and the information processing apparatus 70, via the network 2, and can be realized by means of an NIC or the like.

The operation part 320 is a part through which inputs of various operations are made, and can be realized by means of an input device such as a keyboard, a mouse, a touchpad, or a touch panel.

The display part 330 displays thereon various screens, and can be realized by means of a display device such as a liquid crystal display or a touch panel display.

The storage part 340 stores therein various programs executed by the device management apparatus 30 and data used in various processes performed by the device management apparatus 30. The storage part 340 can be realized by means of at least any of a magnetically-recordable storage device, an optically-recordable storage device, and an electrically-recordable storage device, such as an HDD, an SSD, a memory card, an optical disk, and a RAM. The storage part 340 includes a device-information storage part 341.

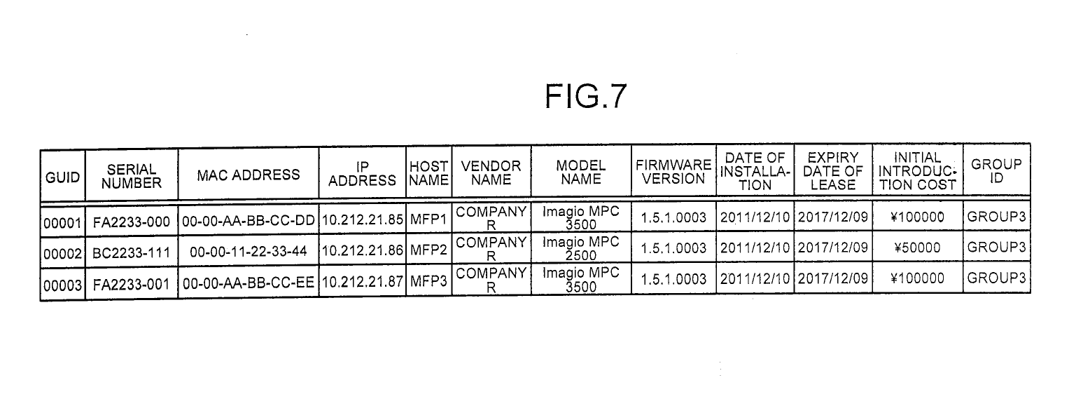

The device-information storage part 341 stores therein device information of the devices 40-1 to 40-n. Incidentally, the device information can be any kind of information as long as the information pertains to device management. FIG. 7 is a diagram showing an example of the device information according to the present embodiment. In the example shown in FIG. 7, the device information is information in which GUID, Serial Number, MAC Address, IP Address, Host Name, Vendor Name, Model Name, Firmware Version, Date of Installation, Expiry Date of Lease, Initial Introduction Cost, and Group ID are associated.

The GUID denotes an identifier that identifies a record of device information (a column of device information). The Serial Number denotes an identifier that identifies a device. The device identified by the Serial Number is owned by a group with the Group ID (specifically, a customer with Customer ID associated with the Group ID in the group information shown in FIG. 5). The MAC Address denotes a MAC address of the device. The IP Address denotes an IP address of the device. The Host Name denotes a host name of the device. The Vendor Name denotes a vendor name of the device. The Model Name (an example of model information) denotes a model name indicating a model of the device. The Firmware Version denotes a version of firmware installed in the device. The Date of Installation denotes the date on which the device was installed (introduced) in customer environment. The Expiry Date of Lease denotes the expiry date of lease of the device to the customer. The Initial Introduction Cost denotes initial cost required for the introduction of the device in the customer environment. The Group ID denotes an identifier that identifies the group.

The control part 350 controls the parts included in the device management apparatus 30, and can be realized by means of a control device such as a CPU. The control part 350 manages the input/output of device information stored in the device-information storage part 341.

For example, the control part 350 acquires device information from the devices 40-1 to 40-n through the communication part 310, and, if the acquired device information is device information of a new device, stores the device information in the device-information storage part 341; if the acquired device information is device information of an existing device, updates device information stored in the device-information storage part 341 with the acquired device information. Specifically, the control part 350 acquires device information by performing communication using a general-purpose protocol commonly used for device management, such as a Simple Network Management Protocol (SNMP), with the devices 40-1 to 40-n. Incidentally, as a method for acquisition of device information, the control part 350 can voluntarily acquire device information from the devices 40-1 to 40-n, or the devices 40-1 to 40-n can voluntarily inform the device management apparatus 30 (the control part 350) of device information.

Furthermore, for example, when Group ID has been input from the information processing apparatus 70 through the communication part 310, the control part 350 acquires a record of device information including the Group ID from the device information stored in the device-information storage part 341 and returns the acquired device information to the information processing apparatus 70. Incidentally, the record of device information that the control part 350 acquires has only to include at least Model Name associated with the Group ID.

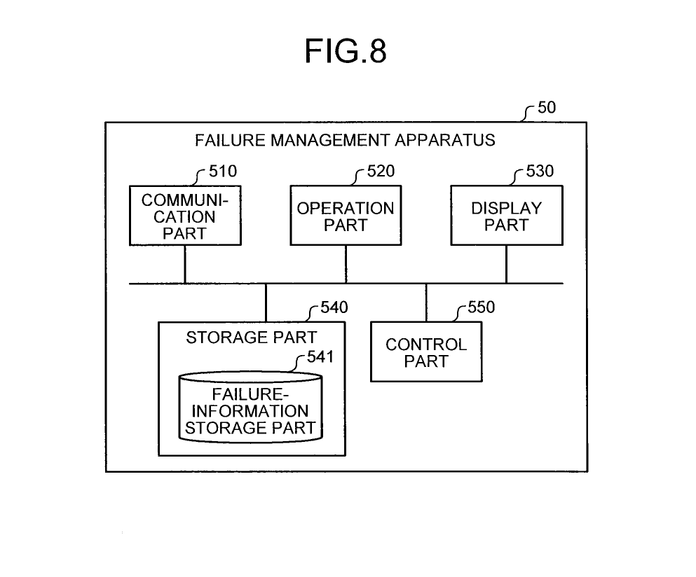

FIG. 8 is a block diagram showing an example of a configuration of the failure management apparatus 50 according to the present embodiment. The failure management apparatus 50 manages failure information (tickets) on failure occurred in the devices 40-1 to 40-n, and, as shown in FIG. 8, includes a communication part 510, an operation part 520, a display part 530, a storage part 540, and a control part 550.

The communication part 510 communicates with an external device, such as the information processing apparatus 70, via the network 2, and can be realized by means of an NIC or the like.

The operation part 520 is a part through which inputs of various operations are made, and can be realized by means of an input device such as a keyboard, a mouse, a touchpad, or a touch panel.

The display part 530 displays thereon various screens, and can be realized by means of a display device such as a liquid crystal display or a touch panel display.

The storage part 540 stores therein various programs executed by the failure management apparatus 50 and data used in various processes performed by the failure management apparatus 50. The storage part 540 can be realized by means of at least any of a magnetically-recordable storage device, an optically-recordable storage device, and an electrically-recordable storage device, such as an HDD, an SSD, a memory card, an optical disk, and a RAM. The storage part 540 includes a failure-information storage part 541.

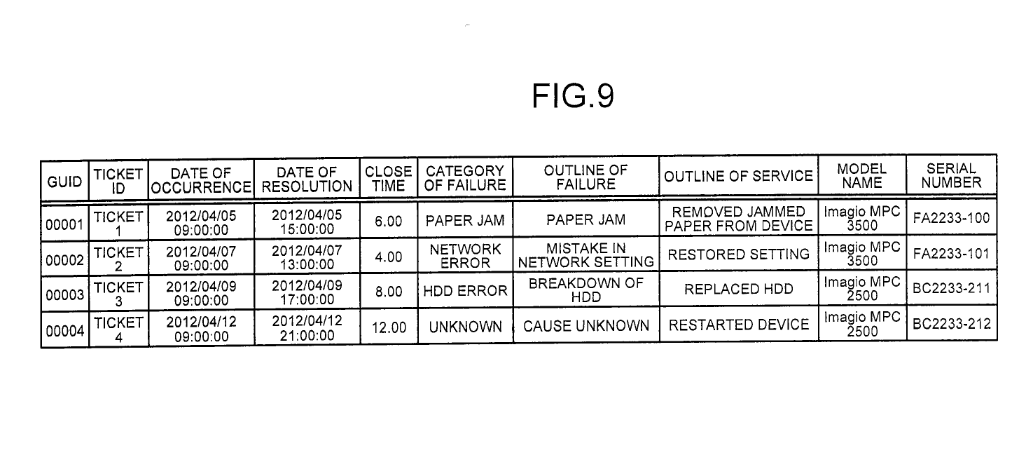

The failure-information storage part 541 stores therein failure information on failure occurred in the devices 40-1 to 40-n. FIG. 9 is a diagram showing an example of the failure information according to the present embodiment. In the example shown in FIG. 9, the failure information is information in which GUID, Ticket ID, Date of Occurrence, Date of Resolution, Close Time, Category of Failure, Outline of Failure, Outline of Service, Model Name, and Serial Number are associated.

The GUID denotes an identifier that identifies a record of failure information (a column of failure information). The Ticket ID denotes an identifier that identifies a failure occurred. The Date of Occurrence denotes the date on which the failure occurred. The Date of Resolution denotes the date on which the failure was resolved. The Close Time (an example of downtime based on failure) denotes a time from when the failure occurred till when the failure was resolved, and is the Date of Resolution minus the Date of Occurrence. A device in which the failure occurred shall be deemed to stop operation during the Close Time. The Category of Failure denotes a category of failure content. The Outline of Failure denotes an outline of the failure content. The Outline of Service denotes an outline of content of service performed to eliminate the failure. The Model Name denotes a model name of the device in which the failure occurred. The Serial Number denotes an identifier that identifies the device in which the failure occurred.

The control part 550 controls the parts included in the failure management apparatus 50, and can be realized by means of a control device such as a CPU. The control part 550 manages the input/output of failure information stored in the failure-information storage part 541.

For example, when new failure information or update of existing failure information has been input by an administrator of the failure management apparatus 50 through the operation part 520, thereby a ticket has been issued or closed, the control part 550 updates the failure information stored in the failure-information storage part 541. Furthermore, for example, when Model Name has been input from the information processing apparatus 70 through the communication part 510, the control part 550 acquires a record of failure information including the Model Name from the failure information stored in the failure-information storage part 541 and returns the acquired information to the information processing apparatus 70. Incidentally, the record of failure information that the control part 550 acquires has only to include at least Close Time associated with the Model Name.

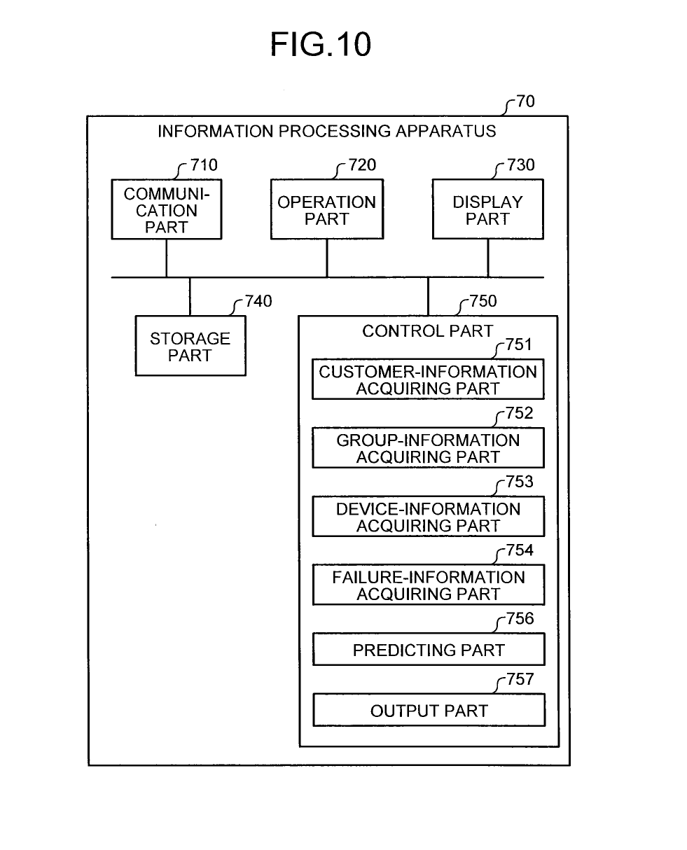

FIG. 10 is a block diagram showing an example of a configuration of the information processing apparatus 70 according to the present embodiment. The information processing apparatus 70 acquires customer information, group information, device information, and failure information from the customer management apparatus 10, the group management apparatus 20, the device management apparatus 30, and the failure management apparatus 50, respectively, and predicts an operation state of a given device. The given device is a device introduced in customer environment of a given customer (or a given customer's group). The information processing apparatus 70 includes, as shown in FIG. 10, a communication part 710, an operation part 720, a display part 730, a storage part 740, and a control part 750.

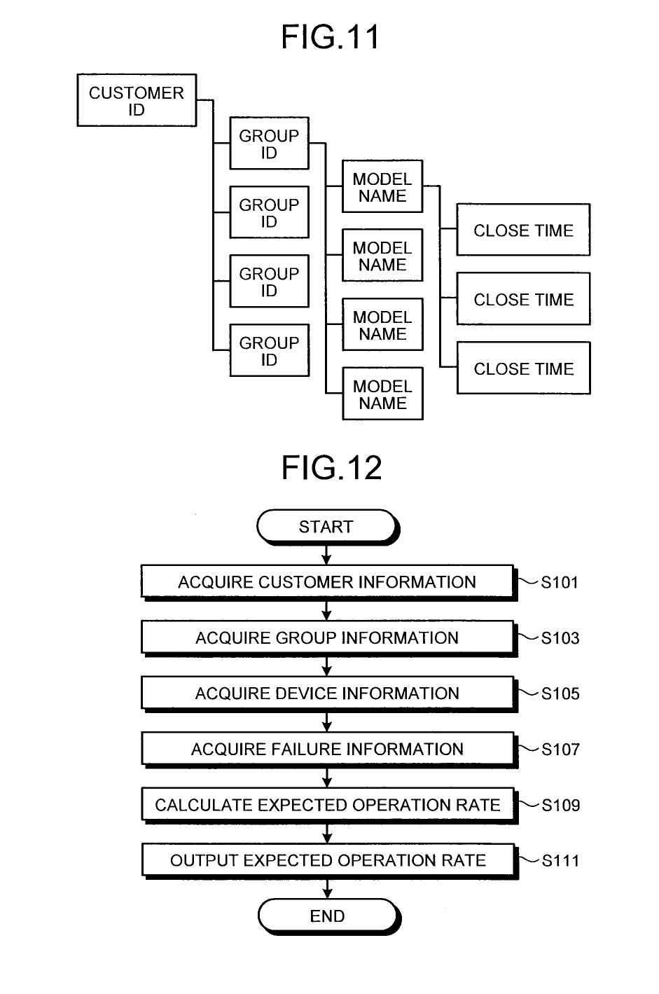

FIG. 11 is a diagram showing an example of a hierarchy of customer information, group information, device information, and failure information according to the present embodiment, and illustrates Customer ID as an example of the customer information, Group ID as an example of the group information, Model Name as an example of the device information, and Close Time as an example of the failure information. Information used for calculation of an expected operation rate has, as shown in FIG. 11, a hierarchical structure that Group ID belongs to Customer ID, Model Name belongs to Group ID, and Close Time belongs to Model Name.

The communication part 710 communicates with external devices, such as the customer management apparatus 10, the group management apparatus 20, the device management apparatus 30, the failure management apparatus 50, and the user terminal 80, via the network 2, and can be realized by means of an NIC or the like.

The operation part 720 is a part through which inputs of various operations are made, and can be realized by means of an input device such as a keyboard, a mouse, a touchpad, or a touch panel.

The display part 730 displays thereon various screens, and can be realized by means of a display device such as a liquid crystal display or a touch panel display.

The storage part 740 stores therein various programs executed by the information processing apparatus 70 and data used in various processes performed by the information processing apparatus 70. The storage part 740 can be realized by means of at least any of a magnetically-recordable storage device, an optically-recordable storage device, and an electrically-recordable storage device, such as an HDD, an SSD, a memory card, an optical disk, and a RAM.

The control part 750 controls the parts included in the information processing apparatus 70, and can be realized by means of a control device such as a CPU. The control part 750 includes a customer-information acquiring part 751, a group-information acquiring part 752, a device-information acquiring part 753, a failure-information acquiring part 754, a predicting part 756, and an output part 757. Here, the control part 750 starts (executes) a program stored in the storage part 740, thereby the customer-information acquiring part 751, the group-information acquiring part 752, the device-information acquiring part 753, the failure-information acquiring part 754, the predicting part 756, and the output part 757 are implemented as software.

The customer-information acquiring part 751 acquires customer information of a given customer. For example, when Name “Company A”, which is a name of a given customer, has been input from the user terminal 80 through the communication part 710, the customer-information acquiring part 751 transmits the Name to the customer management apparatus 10 through the communication part 710, and acquires a record of customer information including the Name (a record of customer information with GUID “00001”) from the customer management apparatus 10 (see FIG. 3).

The group-information acquiring part 752 acquires group information. For example, the group-information acquiring part 752 transmits Customer ID “CUSTOMER001” included in the record of customer information acquired by the customer-information acquiring part 751 to the group management apparatus 20 through the communication part 710, and acquires records of group information including the Customer ID (records of group information with GUIDs “00001 to 00003”) from the group management apparatus 20 (see FIGS. 3 and 5).

The device-information acquiring part 753 acquires device information. For example, the device-information acquiring part 753 transmits Group IDs “GROUP1”, “GROUP2”, and “GROUP3” included in the records of group information acquired by the group-information acquiring part 752 to the device management apparatus 30 through the communication part 710, and acquires records of device information including any of the Group IDs (records of device information with GUIDs “00001 to 00003”) from the device management apparatus 30 (see FIGS. 5 and 7).

Accordingly, the device-information acquiring part 753 acquires device information of given devices introduced in customer environment of the given customer (or the given customer's groups). Incidentally, in this example, the given devices are three devices with Serial Numbers “FA2233-000”, “BC2233-111”, and “FA2233-001”, and Model Name of the devices with Serial Numbers “FA2233-000” and “FA2233-001” is “Imagio MPC 3500”, and Model Name of the device with Serial Number “BC2233-111” is “Imagio MPC 2500”.

The failure-information acquiring part 754 acquires failure information. For example, the failure-information acquiring part 754 transmits Model Names “Imagio MPC 3500” and “Imagio MPC 2500” included in the records of device information acquired by the device-information acquiring part 753 to the failure management apparatus 50 through the communication part 710, and acquires records of failure information including any of the Model Names (records of failure information with GUIDs “00001 to 00004”) from the failure management apparatus 50.

Accordingly, the failure-information acquiring part 754 acquires respective pieces of failure information of the same models of devices as the given devices out of managed object devices. Incidentally, in the present embodiment, the predicting part 756 to be described later predicts a monthly operation state, so the failure-information acquiring part 754 shall acquire monthly failure information; however, an acquisition period is not limited to this. In this example, the failure-information acquiring part 754 acquires failure information from two devices with Model Name “Imagio MPC 3500”, and also acquires failure information from two devices with Model Name “Imagio MPC 2500”.

The predicting part 756 predicts an operation state of a given device on the basis of failure information acquired by the failure-information acquiring part 754. Specifically, the predicting part 756 calculates an expected operation rate of the given device on the basis of Close Time included in the failure information acquired by the failure-information acquiring part 754. Furthermore, the predicting part 756 further calculates an expected operation rate of each model with respect to each of models of multiple given devices. Incidentally, the expected operation rate is a ratio of an expected operation time, which is obtained by subtracting Close Time included in failure information from a predetermined operation time of a given device, to the predetermined operation time. Furthermore, as described above, the expected operation rate shall be an expected monthly operation rate; however, it is not limited to this.

The calculation of an expected operation rate is explained in detail below.

First, from the device information acquired by the device-information acquiring part 753, the predicting part 756 determines that given devices are three devices in total: two devices with Model Name “Imagio MPC 3500” and one device with Model Name “Imagio MPC 2500”. Incidentally, a predetermined monthly operation time of each device shall be 160 hours (8 hours×20 days).

Next, as the failure information acquired by the failure-information acquiring part 754 indicates that respective close times of the devices with Model Name “Imagio MPC 3500” are “6.00” and “4.00”, and respective close times of the devices with Model Name “Imagio MPC 2500” are “8.00” and “12.00”, the predicting part 756 determines that an average close time of the devices with Model Name “Imagio MPC 3500” is 5 hours ((6 hours+4 hours)/2 devices) and an average close time of the devices with Model Name “Imagio MPC 2500” is 10 hours ((8 hours+12 hours)/2 devices). Then, the predicting part 756 calculates respective expected operation times of the given devices with Model Name “Imagio MPC 3500” to be 155 hours (160 hours−5 hours) and an expected operation time of the given device with Model Name “Imagio MPC 2500” to be 150 hours (160 hours−10 hours).

As a result, the predicting part 756 calculates respective expected operation rates of the given devices with Model Name “Imagio MPC 3500” to be 99% (155 hours/160 hours), and calculates an expected operation rate of the given device with Model Name “Imagio MPC 2500” to be 94% (150 hours/160 hours).

Furthermore, the predicting part 756 calculates a total predetermined operation time of the three given devices to be 480 hours (160 hours×3 devices), and calculates a total expected operation time of the three given devices to be 460 hours (480 hours−(5 hours×2 devices+10 hours×1 device)).

As a result, the predicting part 756 calculates a total expected operation rate of the three given devices to be 96% (460 hours/480 hours).

The output part 757 outputs an operation state predicted by the predicting part 756. Specifically, the output part 757 outputs an expected operation rate calculated by the predicting part 756. For example, the output part 757 outputs the expected operation rate calculated by the predicting part 756 to the user terminal 80 through the communication part 710.

The user terminal 80 transmits Name of a given customer to the information processing apparatus 70 through a browser displayed on a display device (not shown), and requests the information processing apparatus 70 to calculate an expected operation rate of a given device. Then, the user terminal 80 acquires the expected operation rate calculated by the information processing apparatus 70, and displays the acquired expected operation rate on the browser.

Subsequently, the operation of the information processing system according to the present embodiment is explained.

FIG. 12 is a flowchart showing an example of an expected-operation-rate calculating process performed by the information processing system 1 according to the present embodiment.

First, when Name of a given customer has been input from the user terminal 80 via the network 2, the customer-information acquiring part 751 of the information processing apparatus 70 transmits the Name to the customer management apparatus 10 via the network 2, and acquires a record of customer information including the Name from the customer management apparatus 10 (Step S101).

Next, the group-information acquiring part 752 of the information processing apparatus 70 transmits Customer ID included in the record of customer information acquired by the customer-information acquiring part 751 to the group management apparatus 20 via the network 2, and acquires a record of group information including the Customer ID from the group management apparatus 20 (Step S103).

Next, the device-information acquiring part 753 of the information processing apparatus 70 transmits Group ID included in the record of group information acquired by the group-information acquiring part 752 to the device management apparatus 30 via the network 2, and acquires a record of device information including the Group ID from the device management apparatus 30 (Step S105).

Next, the failure-information acquiring part 754 of the information processing apparatus 70 transmits Model Name included in the record of device information acquired by the device-information acquiring part 753 to the failure management apparatus 50 via the network 2, and acquires a record of failure information including the Model Name from the failure management apparatus 50 (Step S107).

Next, the predicting part 756 of the information processing apparatus 70 calculates an expected operation rate of a given device on the basis of the device information acquired by the device-information acquiring part 753 and the failure information acquired by the failure-information acquiring part 754 (Step S109).

Next, the output part 757 of the information processing apparatus 70 outputs the expected operation rate calculated by the predicting part 756 to the user terminal 80 via the network 2 (Step S111).

As described above, in the present embodiment, an expected operation rate of a given device is calculated by using failure information managed by the failure management apparatus 50. For example, in the above-described embodiment, the total expected operation rate of the given devices of the given customer is calculated to be 96%, which means a total operation rate of the given devices is expected to be 96%. Therefore, when a service level agreement (SLA) is made with the given customer, contents of the agreement (for example, a target operation rate) can be set with the prospect that a total operation rate of the given devices will be 96%. Therefore, according to the present embodiment, information on a device accumulated every day in management of an operation state of the device can be utilized for MPS, and therefore it is possible to predict device operation information useful in setting contents of an agreement made with a customer.

Incidentally, a given device can be a device to be newly managed by the device management apparatus 30, or can be a device which has already been managed by the device management apparatus 30. In the case where a given device is a device to be newly managed by the device management apparatus 30, a calculated expected operation rate is assumed to be used when an SLA is newly made with a given customer. In this case, the failure management apparatus 50 has not managed failure information of the given device, and therefore an expected operation rate of the given device is calculated by using failure information of devices other than the given device.

On the other hand, in the case where a given device is a device which has already been managed by the device management apparatus 30, a calculated expected operation rate is assumed to be used when an SLA with a given customer is renewed. In this case, the failure management apparatus 50 has managed failure information of the given device, and therefore an expected operation rate of the given device is calculated by using the failure information of the given device and failure information of devices other than the given device. In the calculation of an expected operation rate, the predicting part 756 can calculate an expected operation rate of the given device by weighting the failure information (close time) so that a greater relative weight is added to the failure information (a close time) of the given device.

Furthermore, the failure information managed by the failure management apparatus 50 can be information constructed for the information processing system 1, or can be failure information managed by a report system which makes a service report on an operation state of a device, or can be information synchronized with the failure information managed by the report system. Moreover, the information processing system 1 according to the present embodiment can be implemented as one of functions of the report system which makes a service report on an operation state of a device. Furthermore, in the present embodiment, an operation rate is taken as an example of operation information; however, the operation information is not limited to this, and can be, for example, an operation rate with respect to each category of failure and a rate of occurrence of a specific failure, etc.

Moreover, in the present embodiment, there is described an example where the information processing system 1 is composed of the customer management apparatus 10, the group management apparatus 20, the device management apparatus 30, the devices 40-1 to 40-n, the failure management apparatus 50, the information processing apparatus 70, and the user terminal 80; however, a configuration of the information processing system 1 is not limited to this, and the function of any of the apparatuses can be substituted by another apparatus. For example, the information processing apparatus 70 can be configured to further have the functions of the customer management apparatus 10, the group management apparatus 20, the device management apparatus 30, and the failure management apparatus 50, and the information processing system 1 can be composed of the devices 40-1 to 40-n, the information processing apparatus 70, and the user terminal 80.

Furthermore, in the present embodiment, there is described an example where the customer management apparatus 10 stores therein customer information, the group management apparatus 20 stores therein group information, the device management apparatus 30 stores therein device information, and the failure management apparatus 50 stores therein failure information; alternatively, at least any of these pieces of information can be stored in the outside (for example, on a cloud).

(Hardware Configuration)

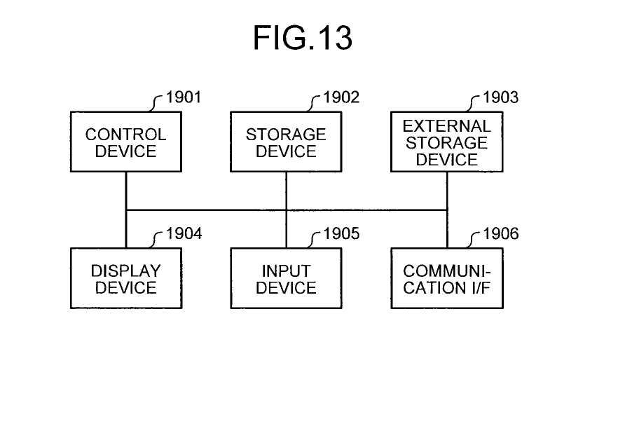

FIG. 13 is a diagram showing an example of a hardware configuration of each of the customer management apparatus 10, the group management apparatus 20, the device management apparatus 30, the devices 40-1 to 40-n, the failure management apparatus 50, the information processing apparatus 70, and the user terminal 80 according to the present embodiment (hereinafter, referred to as each apparatus according to the present embodiment). Each apparatus according to the present embodiment includes a control device 1901 such as a CPU, a storage device 1902 such as a ROM or a RAM, an external storage device 1903 such as an HDD, a display device 1904 such as a display, an input device 1905 such as a keyboard and a mouse, and a communication interface (I/F) 1906, and has a hardware configuration using a normal computer.

A program executed by each apparatus according to the present embodiment is stored in a computer-readable recording medium, such as a CD-ROM, a CD-R, a memory card, a digital versatile disk (DVD), or a flexible disk (FD), in an installable or executable file format, and the storage medium is provided.

Furthermore, the program executed by each apparatus according to the present embodiment can be stored on a computer connected to a network such as the Internet, and the program can be provided by causing a user to download it via the network. Moreover, the program executed by each apparatus according to the present embodiment can be provided or distributed via a network such as the Internet. Furthermore, the program executed by each apparatus according to the present embodiment can be built into the ROM or the like in advance.

The program executed by each apparatus according to the present embodiment is composed of modules for realizing the above-described parts on a computer. A CPU as actual hardware reads out the program from an HDD, and executes the read program on a RAM, thereby the above-described parts are realized on the computer.

According to the present invention, it is possible to utilize accumulated information on a device for service.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a device-information acquiring part configured to acquire device information indicating at least a model of a given device;
a failure-information acquiring part configured to acquire failure information on a failure occurred in a device corresponding to the model indicated by the device information among managed object devices; and
a predicting part configured to predict an operation state of the given device on the basis of the failure information.

2. The information processing system according to claim 1, wherein
the failure information indicates at least a downtime based on the occurred failure, and
the predicting part calculates an expected operation rate of the given device on the basis of the downtime.

3. The information processing system according to claim 2, wherein
the failure-information acquiring part acquires respective pieces of failure information of multiple devices corresponding to the model indicated by the device information, and
the predicting part calculates an expected operation rate of the given device on the basis of respective downtimes of the multiple devices.

4. The information processing system according to claim 2, wherein
there are multiple given devices,
at least one of the multiple given devices differs in model from the other given devices, and
the predicting part further calculates an expected operation rate of each model with respect to each of models of the multiple given devices.

5. The information processing system according to claim 2, wherein
the expected operation rate is a ratio of an expected operation time, which is obtained by subtracting a downtime from a predetermined operation time of the given device, to the predetermined operation time.

6. The information processing system according to claim 4, wherein
with respect to each of the models of the multiple given devices, the predicting part calculates an expected operation time of each model by subtracting a downtime from a predetermined operation time and then calculates an expected operation rate of each model by dividing the predetermined operation time by the expected operation time, and the predicting part further calculates a total predetermined operation time by summing up respective predetermined operation times of the multiple given devices and then calculates a total expected operation time by subtracting respective downtimes of the multiple given devices from the total predetermined operation time, and then calculates a total expected operation rate of the multiple given devices by dividing the total predetermined operation time by the total expected operation time.

7. The information processing system according to claim 1, further comprising an output part configured to output the predicted operation state.

8. The information processing system according to claim 1, further comprising a customer-information acquiring part configured to acquire customer information on a given customer, wherein
the given device is a device introduced in customer environment of the given customer.

9. The information processing system according to claim 8, further comprising a group-information acquiring part configured to acquire group information on a group into which the given customer is arranged, wherein
the given device is a device introduced in customer environment of the group.

10. The information processing system according to claim 9, wherein
the customer information includes at least customer identifying information that identifies the given customer,
the group information includes at least group identifying information that identifies the group and the customer identifying information,
the group-information acquiring part acquires, as the group information, group information including the customer identifying information included in the customer information acquired by the customer-information acquiring part,
the device information includes model information indicating the model and the group identifying information,
the device-information acquiring part acquires, as the device information, device information including the group identifying information included in the group information acquired by the group-information acquiring part,
the failure information further includes model information indicating a model of a device in which failure occurred, and
the failure-information acquiring part acquires, as the failure information, failure information including the model information included in the device information acquired by the device-information acquiring part.

11. An information processing apparatus comprising:
a device-information acquiring part configured to acquire device information indicating at least a model of a given device;
a failure-information acquiring part configured to acquire failure information on a failure occurred in a device corresponding to the model indicated by the device information among managed object devices; and
a predicting part configured to predict an operation state of the given device on the basis of the failure information.

12. An operation-state prediction method comprising:
acquiring device information indicating at least a model of a given device;
acquiring failure information on a failure occurred in a device corresponding to the model indicated by the device information among managed object devices; and
predicting an operation state of the given device on the basis of the failure information.
